(19) United States
(12) Patent Application Publication
(10) Pub. No.: US 2026/0307290 A1
(43) Pub. Date: Oct. 8, 2026

(54) CHAIN SAW WITH A TENSIONING ASSEMBLY

(71) Applicant: DEERE & COMPANY, MOLINE, IL (US)

(72) Inventor: MICHAEL BOYS, CHRISTCHURCH (NZ)

(21) Appl. No.: 19/549,183

(22) Filed: Feb. 25, 2026

(30) Foreign Application Priority Data
Apr. 8, 2025 (EP) 25169187.9

(51) Int. Cl. B27B 17/14; B27B 17/02

(52) U.S. Cl. CPC B27B 17/144; B27B 17/02

(57) ABSTRACT

A chain saw comprising a mount, a guide bar, a chain, and a tensioning mechanism. The mount supports a sprocket driveable to rotate about a rotation axis. The guide bar has a longitudinal axis extending through a distal end of the guide bar and through a rotation axis. The guide bar moves along the longitudinal axis with respect to the mount while in a common plane. A tensioning mechanism comprises a spring, a support connected to the mount, a tensioning screw, and a tension bolt connected to the guide bar. The spring biases the guide bar away from the mount along the longitudinal axis with a force adjustable by the tensioning screw. The tensioning screw extends parallel to the longitudinal axis of the guide bar. The tensioning mechanism is in a direction oriented in the common plane transverse to the longitudinal axis, aligned with the longitudinal axis.

### CROSS REFERENCE TO RELATED APPLICATIONS

The application claims priority under 35 U.S.C. § 119 to European patent application EP 25169187.9, filed on 8 Apr. 2025, the disclosure of which is incorporated herein by reference.

### TECHNICAL FIELD

The present disclosure relates to a chain saw with tensioning assembly for a work machine.

### BACKGROUND

Chain saws are commonly used for cutting wood and may be implemented as hand-held tools or mounted on tree harvesters for felling trees or cutting trunks. A typical chain saw includes a sprocket driven by a motor and a guide bar around in which a saw chain is entrained. The saw chain comprises links with cutting elements. During operation, the chain undergoes wear and elongation, which requires adjustment of the guide bar position to maintain proper chain tension.

Various mechanisms for tensioning a saw chain are known. For example, U.S. Pat. No. 3,194,284 discloses a chain saw having a guide bar with a longitudinal slot at its proximal end through which threaded studs extend. The studs are mounted to a frame plate supporting the driven sprocket, and the guide bar is clamped between the frame plate and a cover plate. The guide bar can slide along the slot, and a tensioning mechanism comprises a compression spring where an adjustable screw biases the guide bar away from the frame plate to tension the chain. The screw extends parallel to the slot and interacts with a nut supported on the cover plate, such that rotation of the screw moves the nut along the slot. The compression spring is clamped between the nut and a lug projecting into an aperture of the guide bar. The force applied to the guide bar is offset laterally from its longitudinal axis within the plane of the guide bar. DE 10 2019 121 221 B4 describes a similar arrangement.

WO 2015/038011 A1 discloses another chain saw apparatus in which a bar holder supporting the guide bar is movably attached to a mount. The bar holder engages a slot in the mount and can slide along the longitudinal axis of the guide bar. A hydraulic tensioner urges the bar holder away from the mount to maintain chain tension. In this design, the tensioning force acts along the longitudinal axis of the guide bar; however, the system requires a hydraulic actuator and associated lines, which adds cost and complexity and limits accessibility for an operator.

A disadvantage of the arrangements disclosed in U.S. Pat. No. 3,194,284 and DE 10 2019 121 221 B4 is that the spring force is introduced at a point offset transversely from the longitudinal axis of the guide bar, which can create canting and frictional forces. The arrangement of WO 2015/038011 A1 avoids this issue by applying force along the longitudinal axis but relies on an expensive hydraulic tensioner that requires hydraulic connections at a location that is difficult for an operator to access.

However, the present configurations are limited in scope. Therein lies an opportunity to address the shortcomings associated with present limited forms of movement.

### SUMMARY

A chain saw comprises a mount, a guide bar, a saw chain, and a tensioning mechanism. The mount supports a sprocket driveable to rotate about a rotation axis. The guide bar has a longitudinal axis extending through a distal end of the guide bar and through the rotation axis of the sprocket. The guide bar is movable along the longitudinal axis with respect to the mount wherein the guide bar and the sprocket lie in a common plane. The saw chain is trained around the sprocket and the guide bar. The tensioning mechanism comprises a spring, a support rigidly connected to the mount; a tensioning screw; and a tension bolt rigidly connected to the guide bar.

The spring biases the guide bar away from the mount along the longitudinal axis with a force that is adjustable by the tensioning screw. The tensioning screw extends parallel to the longitudinal axis of the guide bar. The tensioning mechanism is in a direction oriented in the common plane transverse to the longitudinal axis and aligned with the longitudinal axis.

The spring is a compression spring and the tensioning screw is configured to pull the tension bolt toward the support. The tension bolt is positioned closer to the sprocket than the support.

The compression spring may be positioned between the tensioning screw and the tension bolt. The compression spring may be positioned between the tensioning screw and the support.

The tensioning screw may comprise a head abutting the support, a nut engaging a thread of the tensioning screw, and the compression spring which surrounds the tensioning screw. The compression spring is clamped between a tension block coupled to the nut and the tension bolt. The tension block is one of abutting the nut and the tension bolt or formed integrally with the nut and the tension bolt.

The tensioning screw may comprise a thread engaging a nut abutting the tension bolt, and the compression spring or a thread formed within the tension bolt with the spring clamped between a head of the tensioning screw and the support.

The tensioning screw may comprise a thread formed within the tension bolt, and a compression spring clamped between a head of the tensioning screw and the support.

The tensioning mechanism may be offset from the longitudinal axis in the direction extending transversely to the common plane of the guide bar.

The tension bolt may be mounted to a mounting block connected to the guide bar, the mounting block slidably supported in a recess of the mount for movement parallel to the longitudinal axis in a recess.

The mounting block may be slidably supported on the mount by means of complementary grooves and ridges extending parallel to the longitudinal axis.

The grooves and ridges may be offset from the longitudinal axis in the direction within the common plane of the guide bar and transverse to the longitudinal axis.

The guide bar may be clamped between the mounting block and a clamping block.

The mounting block and the clamping block may be connected by bolts extending through a slot in guide bar extending along axis. The support bridges a distal end of an open slot of the mount, the slot extending parallel to the longitudinal axis, the tensioning mechanism located within the slot. The tension bolt may be mounted to a mounting block connected to the guide bar, the mounting block slidably supported in a recess of the mount for movement parallel to the longitudinal axis, and the slot is open towards the recess.

The spring may comprise one of a urethane spring, a coil spring, and a spring washer stack.

The proximal end of the tensioning screw may be received in a bore of the mount.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a top view of a chain saw;

FIG. 2 is the chain saw of FIG. 1 in an exploded view from top;

FIG. 3 the chain saw of FIG. 1 in an exploded view from bottom;

FIG. 4 is a chain tensioner of the chain saw in exploded view;

FIG. 5 the chain tensioner of FIG. 4 in assembled state;

FIG. 6 is a section through the chain tensioner of FIG. 5 along lines 6-6 of FIG. 5;

FIG. 7 is a section through the chain saw along lines 7-7 of FIG. 1; and

FIG. 8 is a view of a second embodiment of the tensioning mechanism.

### DETAILED DESCRIPTION

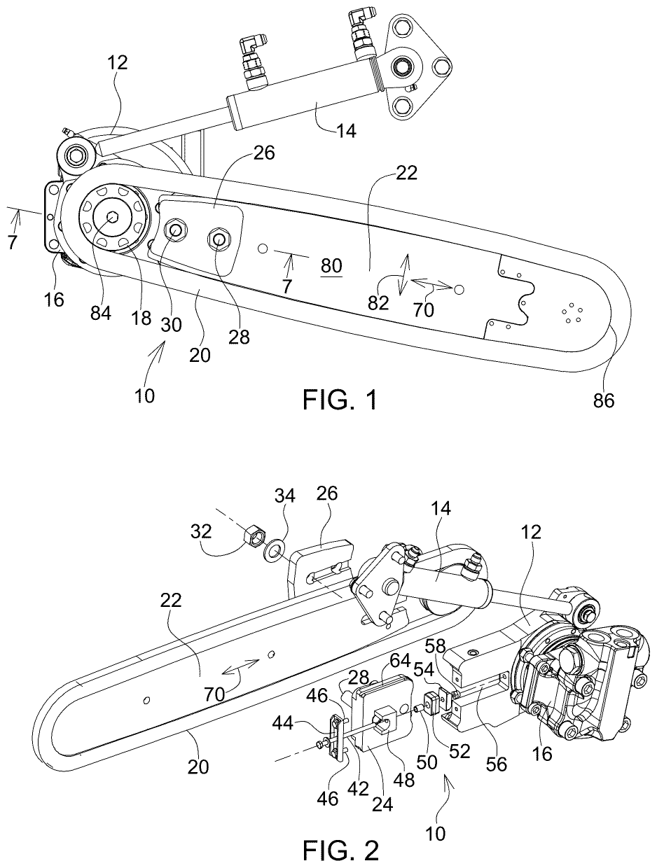

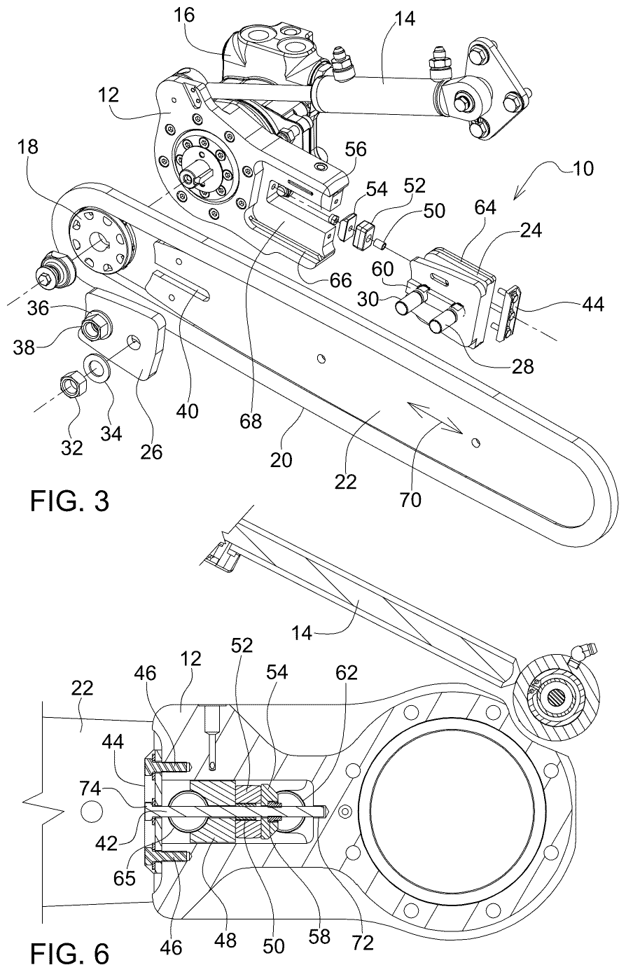

FIGS. 1 to 3 illustrate a chain saw 10 having a mount 12 that supports a sprocket 18 driven around its axis 84 by a motor 16. Mount 12 is rotatable by an actuator 14, allowing the chain saw 10 to move between an operative position for cutting trees and a retracted, inoperative position. The chain saw 10 may alternatively be configured as a hand-held tool without the actuator 14 or mounted on a forestry machine, such as a harvester head. When mounted on a harvester head, the chain saw 10 is typically oriented horizontally as shown from the top in FIGS. 1 and 2 and from the bottom in FIG. 3.

The chain saw 10 further comprises an elongated guide bar 22 around which a chain 20 is trained. Chain 20 also passes around the sprocket 18. For clarity, chain 20 is shown schematically and comprises links with cutting elements. The guide bar 22 and sprocket 18 lie in a common plane 80, which also contains the chain 20.

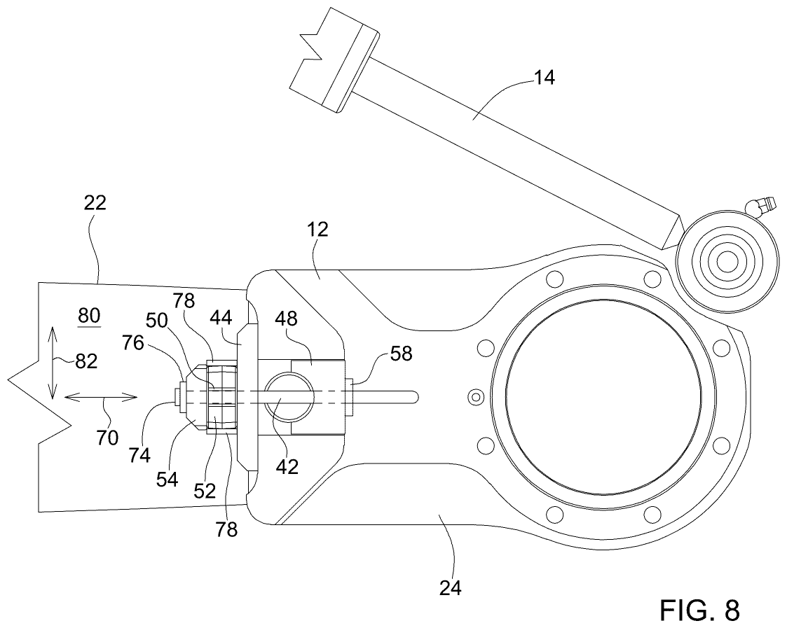

Guide bar 22 is movable along its longitudinal axis 70, which extends through the distal end 86 of the guide bar 22 and the axis 84 of the sprocket 18. Guide bar 22 moves relative to mount 12 and sprocket 18, and is biased towards the distal end (to the right-side FIGS. 1 and 3) to tension the chain 20 by means of a spring 52. The tensioning mechanism is shown in more detail in FIGS. 2 to 7, with a second embodiment illustrated in FIG. 8.

At its proximal end, guide bar 22 includes a longitudinal slot 40 that opens towards the proximal end. The slot 40 receives bolts 28, 30 connect a mounting block 24 on the motor-facing side of the guide bar 22 and a clamping block 26 on the other side of guide bar 22. The mounting block 24 has a ridge 60 that engages the slot 40 for centering. Bolts 28 and 30 are threaded into holes (62, 65) in mounting block 24. Nuts (32, 38) and washers (34, 36) clamp the guide bar 22 between mounting block 24 and clamping block 26. During operation, the mounting block 24 is fixed to guide bar 22. When nuts (32, 38) are loosened, the mounting block 24 and clamping block 26 can slide along the slot 40, i.e., along the longitudinal axis of the guide bar 22, for adjustment, maintenance, or chain replacement. After adjustment, the nuts (32, 38) are tightened to prepare the chain saw 10 for operation. During cutting, no further adjustment of the guide bar 22 along the slot 40 is required, even as the chain 20 lengthens because the tensioning mechanism automatically compensates. The slot 40 may alternatively be replaced by two holes for bolts (28, 30) within guide bar 22.

The mounting block 24 is slidably supported in the mount 12 along the longitudinal axis 70 of the guide bar 22. A cuboidal recess 68 in mount 12 includes longitudinal ridges 66 that engage grooves 64 on mounting block 24. The ridges 66 and grooves 64 are provided on both sides of mounting block 24, as shown in FIG. 3 and extend parallel to the longitudinal axis 70. They offset laterally within the plane of the guide bar 22 and allow guided sliding movement of the mounting block 24 along the longitudinal axis 70.

Additionally, mount 12 further includes a central slot 56 that extends along the longitudinal axis 70 and opens into recess 68. The main components of the tensioning mechanism are housed within this slot.

The tensioning mechanism biases the mounting block 24 and thus the guide bar 22, along the longitudinal axis 70 toward the distal end of the guide bar 22. A support 44 bridges the outer end of the slot 56 and is secured by bolts 46 on both sides. A tensioning screw 42 extends within the slot 56 along the longitudinal axis 70 towards the sprocket 18 and has a head 74 abutting support 44. The tensioning screw 42 passes through a tension bolt 48, a cylinder 50 surrounded by a compression spring 52, a tension block 54, and a nut 58 with its proximal end centered in a bore 72 of the mount 12. The thread of tensioning screw 42 engages only the nut 58 and rotates freely relative to the tension bolt 48, cylinder 50, tension block 54 and bore 72. Rotation of the head 74 moves the nut 58 along longitudinal axis 70. The axial length of cylinder 50 is shorter than the axial length of compression spring 52 when fully compressed. In an embodiment, the nut and tension block 54 may be formed as a unitary part or be permanently joined. Tension bolt 48 is positioned closer to the sprocket 18 than the support 44, so pulling the tension bolt 48 toward the support 44 moves the guide bar 22 away from sprocket 18 toward its distal end 86.

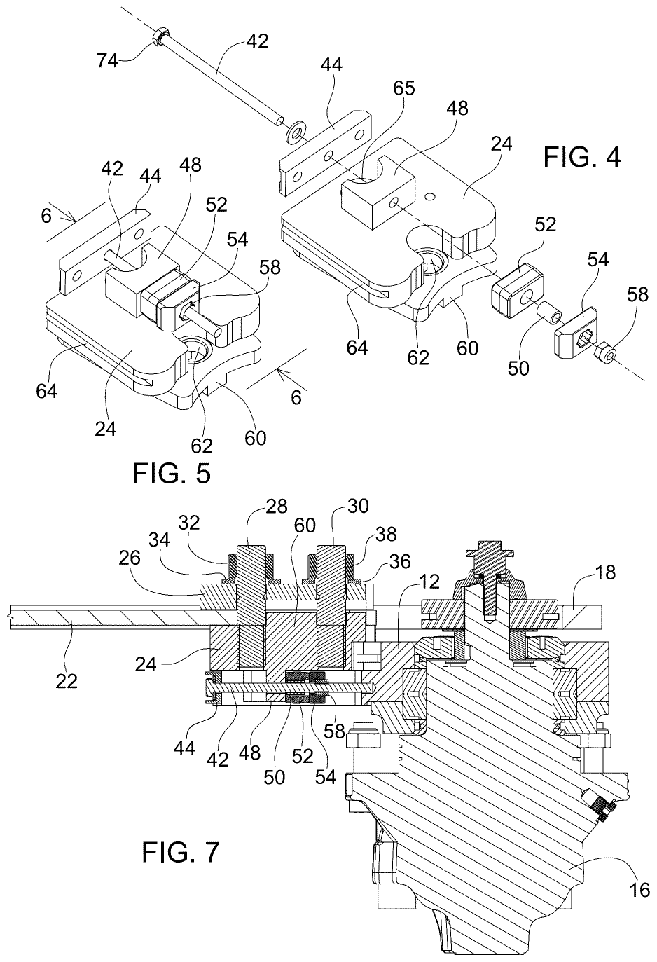

Tension bolt 48 is fixed to the mounting block 24, as shown in FIG. 4. The compression spring 52 is clamped between tension block 54 and tension bolt 48 and supported on the cylinder 50. The nut 58 is rotationally fixed to the tension block 54. In the assembled state, tensioning screw 42 compresses the spring 52 between the tension block 54 and the tension bolt 48, and turning the head 74 of the tensioner screw adjusts the spring force. Spring 52 may be a urethane spring, a coil spring, or stack of spring washers. A force acting on the guide bar 22 along the axis 70 is transmitted through the mounting block 24 and the tension bolt 48 to the spring 52 and from the spring 52 through the tension block 54, nut 58, tensioning screw 42, and support 44 to the mount 12.

The entire tensioning mechanism is aligned parallel to the longitudinal axis 70 of guide bar 22 and offset only in a direction transverse to the common plane 80 of guide bar 22 and sprocket 18 (and chain 20, but not in the direction 82 within the plane of guide bar 22 transverse to the axis 70 (see FIG. 1). This arrangement prevents canting or binding forces within the plane 80 and provides a compact design with the head 74 of tensioning screw 42 positioned for easy access.

FIG. 8 illustrates a second embodiment, similar to FIG. 6, with corresponding parts bearing the same reference numerals. In this embodiment, the spring 52 is mounted between the support 44 and the head 74 of the tensioning screw 42, preferably with a washer 76 and the tension block 54 sandwiched between head 74 and the spring 52. Protruding walls 78 on support 44 prevent the spring 52 from rotating around tensioning screw 42. A nut 58, blocked against rotation by non-circular features interacting with corresponding features on the tension bolt 48, abuts the tension block 48 on the side opposite of support 44 and spring 52. Spring 52 also surrounds the cylinder 50. Alternatively, the nut may be integrated into the tension bolt 48 by providing tensioning bolt 48 with a thread that engages the tensioning screw 42. The mounting block 24 the same as in the first embodiment.

The second embodiment operates generally in the same manner as the first embodiment. The force of the spring 52 is transmitted from the support 44 to the mount 12 and the sprocket 18, and on the other hand from the tension block 54, washer 76, tensioning screw 42, nut 58, tension bolt 48, mounting block 24 and bolts (28, 30) to the guide bar 22. Turning the head 74 of tensioning screw 42 pulls the tension block 54 and thus the guide bar 22 away from mount 12 and sprocket 18 against the force of the spring 52, thereby adjusting chain tension. The main difference from the first embodiment is the location of the spring 52—between the support 44 and screw head 74 in the second embodiment, rather than between the tension bolt 48 and tension block 54.

In another embodiment, not shown, the bolts (28, 30) are inserted into holes (62, 65) from the top side of mounting block 24 (as shown in FIGS. 4 and 5), before the tensioning screw 42 is installed. In this embodiment, the bolts (28, 30) have heads that protrude beyond bore edges of holes 62, 65 to have the bolts 28, 30 fixed in axial direction. The bolts 28, 30 may include features on their heads or shafts near the heads that interact with corresponding features in the holes (62, 65), such as non-circular or rectangular elements, to prevent rotation and allow nuts 32, 38 to clamp the mounting block 24 and clamping block 26 together. To permit insertion of the bolt 28 from the top, the tension bolt 48 includes a concave recess on its side facing the support 44.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A chain saw comprising:
a mount supporting a sprocket driveable to rotate about a rotation axis;
a guide bar having a longitudinal axis, the longitudinal axis extending through a distal end of the guide bar and through the rotation axis of the sprocket, the guide bar movable along the longitudinal axis with respect to the mount, the guide bar and the sprocket lying in a common plane;
a saw chain trained around the sprocket and the guide bar; and
a tensioning mechanism comprising:
a spring;
a support rigidly connected to the mount;
a tensioning screw; and
a tension bolt rigidly connected to the guide bar,
wherein the spring biases the guide bar away from the mount along the longitudinal axis with a force that is adjustable by the tensioning screw,
wherein the tension screw extends parallel to the longitudinal axis of the guide bar; and
wherein the tensioning mechanism is in a direction oriented in the common plane transverse to the longitudinal axis, aligned with the longitudinal axis.

2. The chain saw of claim 1, wherein the spring is a compression spring and the tensioning screw is configured to pull the tension bolt toward the support, the tension bolt positioned closer to the sprocket than the support.

3. The chain saw of claim 2, wherein the compression spring is positioned between the tensioning screw and the tension bolt.

4. The chain saw of claim 2, wherein the compression spring is positioned between the tensioning screw and the support.

5. The chain saw of claim 2, wherein the tensioning screw comprises a head abutting the support, a nut engaging a thread of the tensioning screw, and the compression spring, surrounding the tensioning screw is clamped between a tension block coupled to the nut and the tension bolt, the tension block is one of abutting the nut and the tension bolt or formed integrally with the nut and the tension bolt.

6. The chain saw of claim 2, wherein the tensioning screw comprises a thread engaging a nut abutting the tension bolt, and the compression spring or a thread formed within the tension bolt and the spring clamped between a head of the tensioning screw and the support.

7. The chain saw of claim 2, wherein the tensioning screw comprises a thread formed within the tension bolt, and a compression spring clamped between a head of the tensioning screw and the support.

8. The chain saw of claim 1, wherein the tensioning mechanism is offset from the longitudinal axis in the direction extending transversely to the common plane of the guide bar.

9. The chain saw of claim 1, wherein the tension bolt is mounted to a mounting block connected to the guide bar, the mounting block slidably supported in a recess of the mount for movement parallel to the longitudinal axis in a recess.

10. The chain saw of claim 9, wherein the mounting block is slidably supported on the mount by means of complementary grooves and ridges extending parallel to the longitudinal axis.

11. The chain saw of claim 10, wherein the grooves and ridges are offset from the longitudinal axis in the direction within the common plane of the guide bar and transverse to the longitudinal axis.

12. The chain saw of claim 9, wherein the guide bar is clamped between the mounting block and a clamping block.

13. The chain saw of claim 12, wherein the mounting block and the clamping block are connected by bolts extending through a slot in guide bar extending along axis.

14. The chain saw of claim 1, wherein the support bridges a distal end of an open slot of the mount, the slot extending parallel to the longitudinal axis, the tensioning mechanism located within the slot.

15. The chain saw of claim 11, wherein the tension bolt is mounted to a mounting block connected to the guide bar, the mounting block slidably supported in a recess of the mount for movement parallel to the longitudinal axis, and the slot is open towards the recess.

16. The chain saw of claim 1, wherein the spring comprises one of a urethane spring, a coil spring, and a spring washer stack.

17. The chain saw of claim 1, wherein the proximal end of the tensioning screw is received in a bore of the mount.
